(19) United States
(12) Patent Application Publication
(10) Pub. No.: US 2020/0036094 A1
(43) Pub. Date: Jan. 30, 2020

(54) ACTUATOR

(71) Applicant: AUMA Riester GmbH & Co. KG, Mullheim (DE)

(72) Inventors: Rudiger Stenzel, Hilchenbach (DE); Andreas Ortlieb, Staufen (DE); Dennis Bruch, Wenden (DE)

(73) Assignee: AUMA Riester GmbH & Co. KG, Mullheim (DE)

(21) Appl. No.: 16/503,704

(22) Filed: Jul. 5, 2019

(30) Foreign Application Priority Data
Jul. 5, 2018 (DE) 102018116337.1

(51) Int. Cl. H01Q 3/00; H04W 52/42; H04W 52/02; H04W 24/08

(52) U.S. Cl. CPC H01Q 3/005; H04W 24/08; H04W 52/0229; H04W 52/42

(57) ABSTRACT

A system (1) including a control center (3) and at least one actuator (2) with a communication unit (5) which is designed to communicate with the control center (3) via at least one radio link (6) in the sub-GHz range.

### BACKGROUND

The invention describes an actuator with a communication unit which is designed to communicate with a control center via a radio link.

Actuators normally have a local service interface via which a configuration and fault diagnosis can be carried out.

This service interface can be designed as wired or wireless. Wireless radio links via WLAN or Bluetooth known in the prior art are normally used. However, these have a very short range, so that a certain physical proximity must exist in order to use the service interface.

In order to carry out, for example, a diagnosis on all actuators of a system, a technician must go to all actuators, despite the radio link. Particularly in the case of large systems with actuators arranged in a distributed manner, a substantial amount of time is therefore required.

### SUMMARY

The object of the invention is to provide an actuator of the aforementioned type whose service interface is also usable from a greater distance.

This object is achieved by an actuator with one or more features of the invention.

The actuator according to the invention is characterized, in particular, in that, in the case of an actuator of the aforementioned type, the radio link is located on a frequency band in the sub-GHz range. The transmission frequency that is used is less than 1 GHz. In Germany, for example, the frequency bands EU433, with frequencies between 433.05 MHz and 434.79 MHz, and EU863-870, with frequencies between 863 MHz and 870 MHz, are permitted for the wireless transmission. In other countries, different and/or additional frequency bands may also be permitted. Due to the longer wavelength of the radio waves compared, for example, with the conventional 2.4 GHz frequency band, a substantially greater range is achieved.

A plurality of protocols, for example 6LoWPAN, WMBUS, SigFox, LoRaWAN or others, are available for the data transmission.

It is particularly advantageous if the radio link uses the LoRaWAN protocol. In this way, ranges up to more than 20 km are possible. Widely distributed actuators can thus be conveniently reached from a control center at a central location, even in very large systems.

A further advantage lies in the very low energy consumption of the LoRaWAN. In one advantageous design, the actuator has a local and/or autonomous energy supply. This offers the advantage that an actuator can be operated over a very long time period with a compact battery at very remote locations which are not readily accessible.

In one advantageous design, the actuator has at least one directional antenna. The range can be increased and/or the energy consumption reduced through alignment of the transmission and receiving antennas.

In particular, the antenna of the actuator can be designed as a directional antenna which is aligned with the control center or an intermediate station. In principle, the antenna of the control center can also be directional. However, if the actuators in the network are arranged in a distributed manner around the control center, an omnidirectional antenna may be advantageous.

In one advantageous design, the actuator has a plurality of antennas.

The antennas can be used simultaneously to minimize transmission errors by the use of antenna diversity.

The antennas can also be selected according to signal quality or distance, so that only one suitable antenna is ever active. It is particularly advantageous if antennas with different amplifications are present.

It can be particularly advantageous if the transmit power is increased when the signal quality is poorer, and vice versa.

Due to the long wavelength, the penetration of the radio link is reasonably good. However, it may be advantageous in the case of actuators with a metal housing or in the case of very long distances if at least one antenna is disposed outside a housing of the actuator.

However, it may also be appropriate if the antenna is disposed separately from the housing at a location favorable for the radio link, for example in an elevated position on a roof or mast.

The radio links in the network can all be in the same frequency band. In one advantageous design, the communication unit can be designed to use different frequency bands. A frequency band with a lower frequency can thus be used, for example, for a more distantly located actuator. The control center and/or the actuator can be designed in such a way that they determine the distance independently and automatically select a corresponding frequency.

It can be advantageous if the actuator has at least one assigned antenna for each frequency. In this way, the antenna can be optimally tuned to the frequency, as a result of which a better transmit and receive power is possible.

In one further advantageous design, the actuator has at least two antennas for each frequency and, as described above, the antenna is selected according to signal quality and or distance.

In principle, it can be advantageous if the transmit power is adjusted according to the distance, as a result of which energy is saved by reducing the transmit power, particularly over short distances.

In one advantageous development of the invention, the communication unit simultaneously maintains two radio links with the control center. These radio links can be equivalent and therefore redundant. However, it may also be advantageous if one radio link is used exclusively for transmission, while the other serves exclusively for reception.

However, it is particularly advantageous if the radio links use different frequencies. These frequencies may be in the same frequency band or in different frequency bands. In the example from above, one radio link would accordingly use a frequency in the 433 MHz band, the other in the SRD 868 MHz band. In this way, the communication is less susceptible to interference. It is particularly advantageous if the radio links redundantly transmit the same data.

In one advantageous design, the transmit power is adjusted according to the transmission frequency, wherein, in particular, the transmit power is higher at high frequencies and lower at low frequencies. An energy-saving operation is possible as a result and the two transmit frequencies thereby achieve roughly the same range.

In one design of the invention, the actuator has an autonomous and/or local energy supply. This means that no access to a power network is present. This may be advantageous particularly at remote locations, for example along a pipeline. An operation over a very long time period, in particular up to several years, is possible due to the low energy consumption of the communication unit. The energy supply can be implemented, for example, via an accumulator which is fed via a solar cell.

In order to achieve a further energy-saving here, it may be appropriate if the radio link is activated only periodically or at defined times and/or only with an adequate energy supply. It can be provided here that the times at which the actuator is accessible, i.e. the radio link can be activated or is activated, are stored and evaluated in a control center.

In one advantageous design, the actuator has an energy-saving mode in which only the communication unit is activated. A control of the actuator, in particular a present drive motor and the associated power control are, however, deactivated.

The energy-saving mode can preferably be ended from outside by a wake-up signal which is received via the radio link. In this case, it can be decided by evaluating the wake-up signal whether the drive controller is to be activated. It is advantageous if the wake-up signal contains additional information.

The invention furthermore comprises a control center with a communication unit which is designed to communicate with an actuator according to the invention via a wireless radio link, wherein the radio link is located on a frequency band in the sub-GHz range.

With one or more actuators according to the invention, a control center essentially forms a star-shaped network in which only one control center is normally present. Due to the long range of the radio link, the control center can be set up at a location which is conveniently and simply reachable or accessible. The control center can also be a mobile control center, for example a mobile computer or tablet.

The invention is particularly advantageously usable in a system consisting of a control center and at least one actuator according to the invention.

### BRIEF DESCRIPTION OF THE DRAWINGS

The invention is explained in detail below on the basis of a preferred example embodiment with reference to the attached drawings.

In the drawings:

FIG. 1: shows a point-to-point network with a control center according to the invention and a plurality of actuators according to the invention,

FIG. 2: shows a flow diagram for setting up a radio link from the control center,

FIG. 3: shows a flow diagram for setting up a radio link from the actuator,

FIG. 4: shows a flow diagram for waking up an actuator from the control center,

FIG. 5: shows a flow diagram of the wake-up procedure from the actuator,

FIG. 6: shows a flow diagram for routing a radio link from the control center, and

FIG. 7: shows a flow diagram for routing a radio link from the actuator.

### DETAILED DESCRIPTION

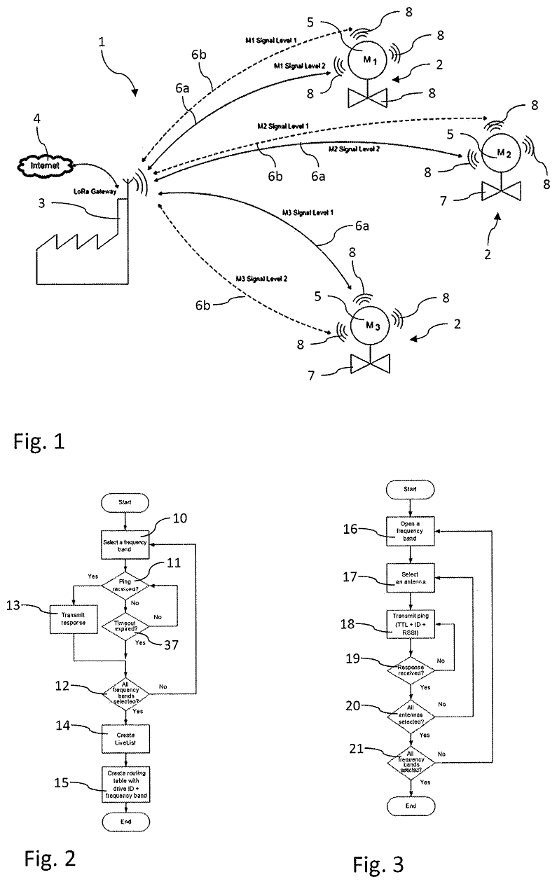

FIG. 1 shows, by way of example, a system 1 formed of a plurality of actuators 2 and a control center 3. In the example, the control center 3 is represented as a building. However, the control center 3 is not tied to a location and can also be formed by a mobile computer or a tablet.

The control center 3 can additionally be connected to the Internet 4, as a result of which remote access to the control center 3 and therefore to the system 1 is also possible. The control center 3 has an antenna 8 via which radio links can be set up to the control center 3. It will be clear to the person skilled in the art that the control center can also have a plurality of antennas 8.

In the example, three actuators 2 are disposed in the system 1. Each actuator 2 has a communication unit 5 with which a point-to-point radio link 6 is or can be set up to the control center 3. The actuators 2 together with the control center 3 form a closed network.

Along with the communication unit 5, an actuator 2 normally has an actuating system 7 which has, for example, a drive motor which drives an actuator. An actuating system 7 of this type may, for example, be a valve or slider. The type of the actuator 2 is irrelevant to the invention, and for this reason only the details which are helpful for the understanding of the invention are provided here. The invention is not intended to be limited in any way to one of the specified actuators 2.

According to the invention, the network of the system 1 is based on point-to-point radio links 6 between the control center 3 and each actuator 2. The radio links 6 use a frequency band in the sub-GHz range. They accordingly have a frequency which is less than 1 GHz. A radio link uses a frequency permitted in the respective country. Some examples of frequency bands and frequencies in selected countries are indicated in the following table. A complete list of the permitted frequencies in all countries can be obtained via the LoRa Alliance™.

| Country | Band | Frequency | |
|---|---|---|---|
| Germany | EU433 | 433.05-434.79 | MHz |
| (EU) | EU863-87 | 863-870 | MHz |
| USA | US902-928, AU915-928 | 902-928 | MHz |
| Russia | RU864-870 | 866-868 MHz (Licensed) | |
| | RU864-870 | 864-865 | MHz |
| | RU864-870 | 868.7-869.2 | MH |
| | EU433 | 433.075-434.75 | MHz |
| | Other | 916-921 MHz (Licensed) | |
| China | AS923 | 920.5-924.5 | MHz |
| | CN779-787 | 779-787 | MHz |
| | CN470-510 | 470-510 | MHz |
| | EU433 | 433.05-434.79 | MHz |
| | Other | 314-316 | MHz |
| | Other | 430-432 | MHz |
| | Other | 840-845 | MHz |

The invention is not therefore restricted to a specific frequency band. However, it may be appropriate to adapt the actuator, in particular the antenna or antennas, for one or more frequency bands permitted in the respective target area, since the antennas can thus attain an optimum transmit and receive power.

In the example, the actuators 2 are designed in such a way that they set up and maintain two radio links 6 simultaneously to the control center 3. The two radio links 6 use different frequency bands. For this purpose, the actuators 2 in each case have at least one antenna 8 which is permanently assigned to one frequency band. The antenna 8 can thus be tuned precisely to the respective frequency band. A respective first radio link 6a uses, for example, a frequency band with a frequency in the EU433 band approved in the EU. A respective second radio link 6b uses, for example, the EU863-870 frequency band. Other approved or regulated frequency bands can obviously also be used.

The antennas 8 of the actuators 2 can optionally be directional antennas which are aligned with the control center 3, as a result of which the range can be increased or the energy consumption can be reduced.

In the example, the two radio links 6 are designed as redundant. This means that all data are transmitted in each case in parallel via both radio links 6. Since the two frequency bands have different susceptibilities to interference, one source of interference does not necessarily affect both radio links 6. A very high transmission reliability is thereby achieved.

In the example, the LoRaWAN protocol is used for the radio links 6. This protocol has a very long range, a low energy consumption and a simple implementation.

Due to the low energy consumption of the actuator 2, the energy supply can be implemented, for example, by means of a local energy supply. Particularly at remote locations, an actuator 2 can be fed, for example, via a solar panel, a wind turbine or via water power.

In order to set up a radio link 6 in the system 1, an actuator 2 must first be initialized in the network.

This initialization is performed from the control center 3 according to the flow diagram shown in FIG. 2.

To do this, a frequency band is first selected 10 in the control center on which ping messages are received 11. A ping message of this type is sent by an actuator in the initialization, as will be explained later with reference to FIG. 3.

If no ping message has been received even after a predefined waiting time 34, a check is carried out to ascertain whether all possible frequency bands have already been checked 12. If not, the reception is repeated 10 on a different frequency band.

However, if a ping message has been received, a response is transmitted 13 and the check 12 to determine whether all frequency bands have been checked is continued.

If all frequency bands have been checked, a list of the radio links is created 14. A routing table is then created which contains at least one unique address (ID) of an actuator and the frequency band of the radio link. This routing table serves later to set up a radio link for the data transmission and for the definition of the network.

FIG. 3 shows a flow diagram of the initialization from the actuator 2. The actuator 2 first opens a frequency band 16. A suitable antenna 8 is selected 17 for this purpose. A ping message is then transmitted 18. This ping message contains at least one unique identifier (ID) of the actuator 2, a receive signal strength (RSSI) and a validity period (TTL) within which the message can be answered.

A check is then carried out 19 to ascertain whether a response has been received from the control center 3. If not, a new ping message is transmitted 18.

As soon as a response has been received, a check is carried out 20 to determine whether all existing antennas 8 have already been selected. If not, the selection 17 of a new antenna is continued.

If so, a check is carried out 21 to ascertain whether all frequency bands have been selected. If not, the opening 16 of a new frequency band is continued. If so, the initialization is ended.

The control center 3 now has in its routing table all antennas and frequency bands via which the actuator 2 is reachable.

For further energy-saving, the actuator 2 has a sleep mode in which no permanent radio link is maintained. The communication unit is, for example, periodically activated in order to receive wake-up signals.

In addition, the actuating system can also be in an energy-saving mode 38.

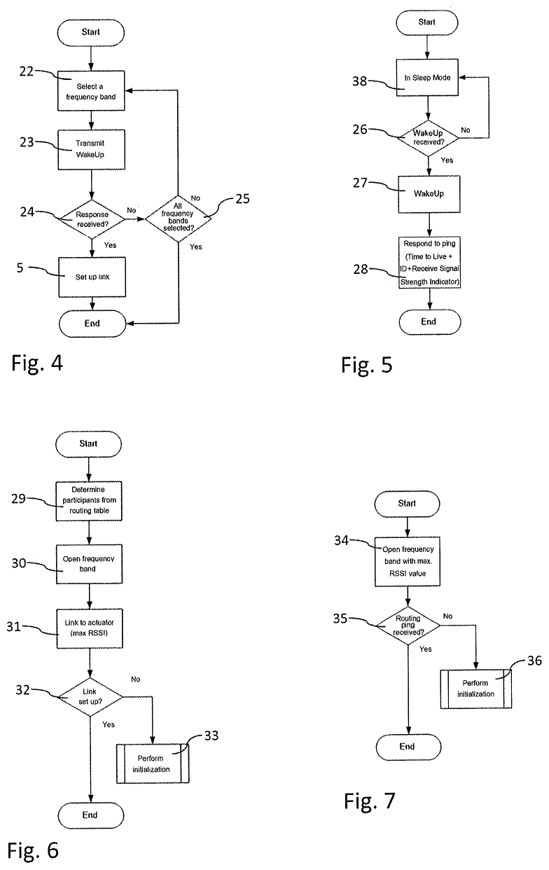

In order to wake up an actuator 2, the control center 3 transmits a wake-up signal to an actuator 2 according to the flow diagram shown in FIG. 4. A frequency band is first selected 22 and a wake-up signal is transmitted 23.

If a response to the wake-up signal has been received 24, a radio link is set up to the actuator.

If no response has been received, a check is first carried out 25 to ascertain whether all frequency bands have been selected. If not, a new frequency band is selected 22 and the procedure is repeated. Otherwise, the wake-up was unsuccessful and is ended.

The actuator 2 is in sleep mode 38 according to FIG. 5. Here, a check is periodically carried out 26 to ascertain whether a wake-up signal has been received.

If so, the actuator is woken up 27 and a ping message is transmitted 28 which, as in the case of the ping message of the initialization, contains at least one ID, a TTL and an RSSI.

The communication with an actuator 2 takes place according to the flow diagram shown in FIG. 6. The actuator 2 with which a radio link 6 is intended to be set up, is determined 29 from the routing table. The frequency band stored there is opened 30 and a radio link is set up 31, wherein the maximum transmit power is initially used. If the connection could not be set up 32, an initialization is carried out 33 according to FIG. 2. Otherwise, communication can take place via the radio link.

On the actuator side, the routing takes place according to the flow diagram shown in FIG. 7. The actuator 2 opens 34 a frequency band initially with the maximum power and waits 25 for the reception of a response from the control center 3. If this does not happen, an initialization is carried out 36 according to FIG. 3.

### REFERENCE NUMBER LIST

1 Network

2 Actuator

3 Control center

4 Internet

5 Communication unit

6 Radio link

6a Radio link frequency band 1

6b Radio link frequency band 2

7 Actuating system

8 Antenna

10 Select frequency band

11 Receive ping message

12 All frequency bands selected?

13 Transmit response

14 Create list of participants

15 Create routing table

16 Open frequency band

17 Select antenna

18 Transmit ping message

19 Response received?

20 All antennas selected?

21 All frequency bands selected?

22 Select frequency band

23 Transmit wake-up signal

24 Response received?

25 All frequency bands selected?

26 Wake-up signal received?

27 Wake up

28 Transmit response

29 Determine participants

30 Open frequency band

31 Set up radio link

32 Radio link set up?

33 Perform initialization

34 Open frequency band

35 Response received?

36 Perform initialization

37 Waiting time expired?

38 Actuator in sleep mode

1. An actuator (2) comprising:
a communication unit (5) configured to communicate with a control center (3) via a radio link (6), and
at least one antenna (8) connected to the communication unit (5), wherein the radio link (6) is located on a frequency band in a sub-GHz range.

2. The actuator as claimed in claim 1, wherein the radio link (6) uses a LoRaWAN protocol.

3. The actuator as claimed in claim 1, wherein the at least one antenna (8) is a directional antenna.

4. The actuator as claimed in claim 1, further comprising a housing, and the at least one antenna (8) is disposed outside the housing.

5. The actuator as claimed in claim 1, wherein the at least one antenna comprises a plurality of antennas (8) which are usable individually or jointly.

6. The actuator as claimed in claim 1, wherein the communication unit (5) is configured to simultaneously maintain two radio links (6) to the control center (3).

7. The actuator as claimed in claim 6, wherein the communication unit (5) is configured to adjust a transmit power according to a transmission frequency, in particular wherein the transmit power is higher at high frequencies.

8. The actuator as claimed in claim 1, further comprising at least one of autonomous energy supply.

9. The actuator as claimed in claim 1, further comprising an energy-saving mode which is adapted to be ended through reception (26) of a wake-up signal.

10. A control center (3) with a communication unit configured to communicate with the actuator (2) as claimed in claim 1, via the radio link (6), wherein the radio link (6) is located on the frequency band in the sub-GHz range.

11. A system (1) comprising control center (3) as claimed in claim 10 and a plurality of the actuators (2) which are connected in each case via the radio link (6) which is a point-to-point radio link (6) to the control center (3).

12. The actuator as claimed in claim 5, wherein one of the plurality of antennas (8) is used according to signal quality.

13. The actuator as claimed in claim 6, wherein the two radio links (6) use two different frequency bands.

14. The actuator as claimed in claim 13, wherein a separate one of the antennas (8) is present for each said radio link (6).

15. The actuator as claimed in claim 7, wherein the transmit power is configured to be higher at high frequencies.

16. The actuator as claimed in claim 1, wherein the radio link (6) is activated only periodically or only with an adequate energy supply or only periodically with an adequate energy supply.

17. The control center as claimed in claim 10, wherein the control center (3) is configured to store and evaluate times at which the actuator (2) is reachable.
